(19) United States
(12) Patent Application Publication
(10) Pub. No.: US 2020/0307946 A1
(43) Pub. Date: Oct. 1, 2020

(54) DEVICE TO ASSIST WITH UNTYING ROPE KNOTS

(71) Applicant: Malcolm John Brodie, West Vancouver (CA)

(72) Inventor: Malcolm John Brodie, West Vancouver (CA)

(21) Appl. No.: 16/372,347

(22) Filed: Apr. 1, 2019

(51) Int. Cl. B65H 47/00

(52) U.S. Cl. CPC B65H 47/00; B25B 33/00

(57) ABSTRACT

A device to assist with untying rope knots comprises an elongate body having a first end and a second end. There is an enlarged tip portion extending from the first end of the elongate body. The enlarged tip portion increases in diameter from a proximal end thereof to an intermediate portion and decreases in diameter from the intermediate portion to a distal end thereof. The enlarged tip portion is configured to be inserted into a loose knot in a rope so that the enlarged tip portion inhibits the device from slipping out of the knot after the knot is tightened. When removing the device from the knot, the enlarged tip portion further expands the knot relative to the elongate body so as to facilitate untying the knot.

### TECHNICAL FIELD

The present disclosure relates to a device to assist with untying rope knots and, in particular, to a device to assist with untying knots in climbing ropes.

### BACKGROUND

International Patent Publication No. WO 2014/056719, which published on Apr. 17, 2014 in the name of Schröder, discloses a pin for inserting into a knot of a main cable in order to prevent the main cable from completely tightening. The pin comprises an elongated profiled section with a free end which can be inserted through the knot. There is at least one flexible fixing means which is fixed to another profiled section end opposite the free end. The at least one fixing means comprises at least one free fixing means end that can be placed about the outside of the knot when the free end is inserted through the knot, and a removable closure between the free end and at least one of the free fixing means ends. The closure removably closes the free end inserted through the knot with the at least one fixing means end placed around the outside of the knot.

### SUMMARY

There is provided a device to assist with untying rope knots, the device comprising an elongate body having a first end and a second end. There is an enlarged tip portion extending from the first end of the elongate body. The enlarged tip portion increases in diameter from a proximal end thereof to an intermediate portion and decreases in diameter from the intermediate portion to a distal end thereof. The enlarged tip portion is configured to be inserted into a loose knot in a rope so that the enlarged tip portion inhibits the device from slipping out of the knot after the knot is tightened.

The enlarged tip portion may include a frusto-conical portion proximal to the elongate body and a conical portion terminating in a pointed free end. The frusto-conical portion may flare radially outwardly from the elongate body towards the conical portion. The pointed free end may be rounded. The second end of the elongate body may be chamfered.

The elongate body may include a through hole near the second end thereof. The through hole may receive one end of a release member to assist in removal of the device from the knot. The other end of the release member may be connectable to a climbing harness. The through hole may have a chamfered edge.

There is also provided a method of tying and untying a knot in a rope. The method comprises providing the device disclosed herein to assist with untying rope knots. A loose knot is formed in a rope. The enlarged tip portion of the device is inserted into the knot such that the knot tightens over the device when the rope is under tension during use. The device is removed from the knot after use, thereby expanding the knot. The expanded knot in the rope can then be untied.

Removing the device from the knot may include pulling on a release member connected to the second end of the device opposite to the enlarged tip portion. The release member may be connected to a climbing harness prior to inserting the enlarged tip portion of the device into the knot.

There is further provided a combination of a rope and a device for untying a knot in the rope. The device comprises an elongate body having a first end and a second end, and an enlarged tip portion extending from the first end of the elongate body. The enlarged tip portion increases in diameter from a proximal end thereof to an intermediate portion and decreases in diameter from the intermediate portion to a distal end thereof. When the device is inserted into a loose knot formed in the rope, the enlarged tip portion retains the device in the loose knot as the knot is partially tightened, and the elongate body inhibits the knot from fully tightening, thereby facilitating untying of the knot.

### BRIEF DESCRIPTION OF THE DRAWINGS

FIG. 1 is a perspective view of a device to assist with untying rope knots, the device being shown inserted into a loose knot of a rope;

FIG. 2 is a front perspective view of the device of FIG. 1;

FIG. 3 is a rear perspective view of the device of FIG. 1;

FIG. 4 is a side view of the device of FIG. 1;

FIG. 5 is a front end view of the device of FIG. 1;

FIG. 6 is a rear end view of the device of FIG. 1;

FIG. 7 is a perspective view of the device of FIG. 1 showing the knot tightened around the device; and

FIG. 8 is a flowchart showing the steps of using the device of FIG. 1 to assist in untying a rope knot.

### DESCRIPTION OF SPECIFIC EMBODIMENTS

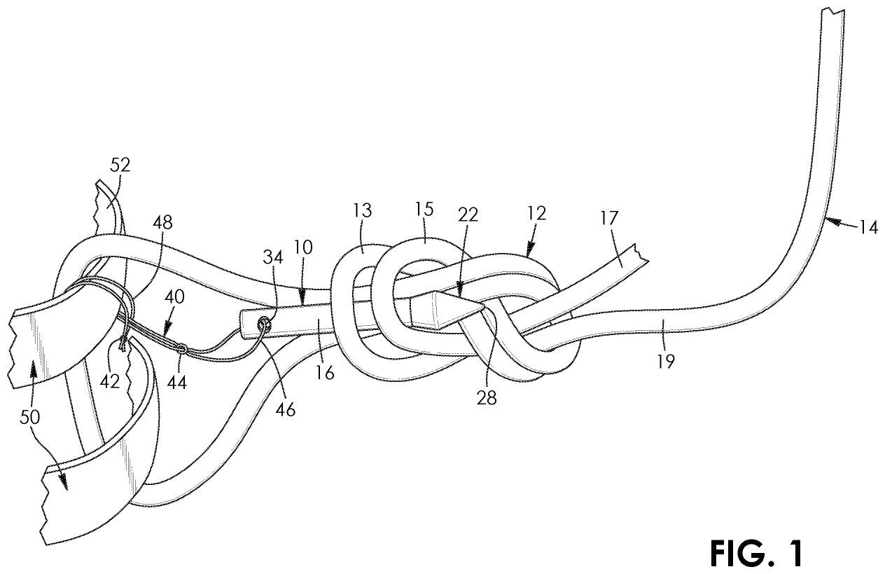

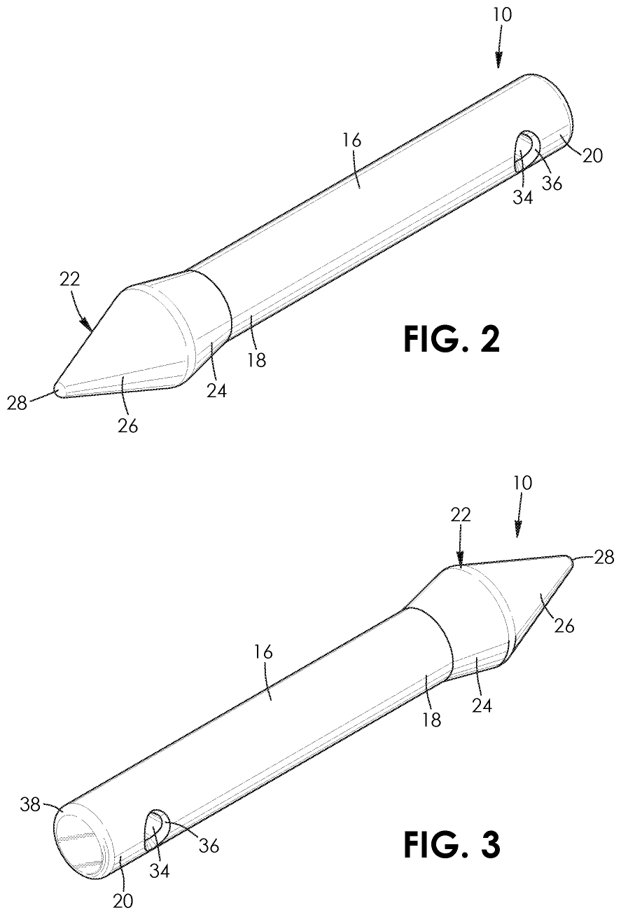

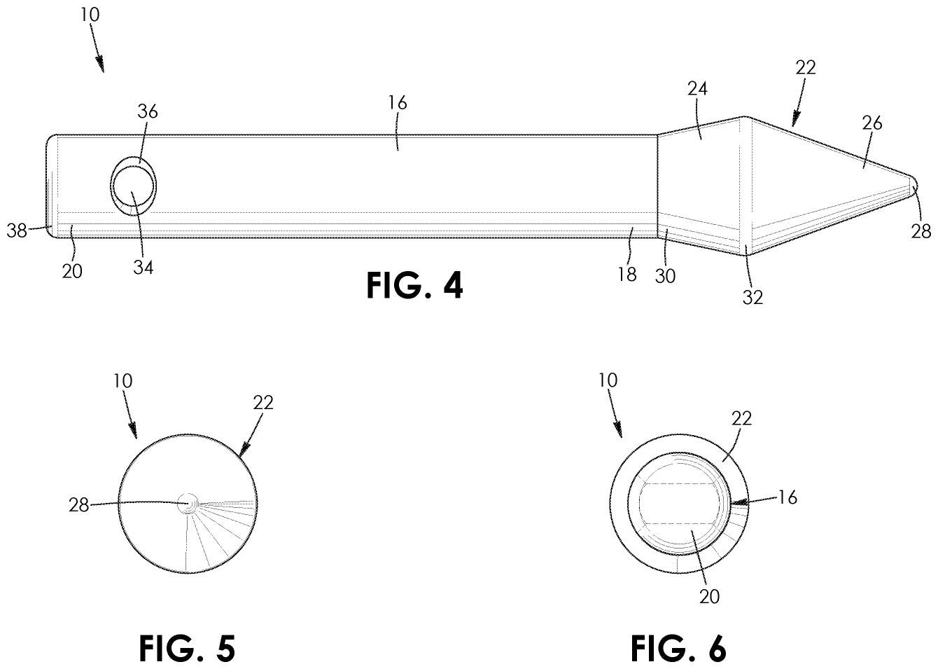

Referring to the drawings and first to FIG. 1, there is shown a device 10 to assist with untying a knot 12 in a rope 14. The rope 14 may be a dynamic rope used in rock climbing, ice climbing or mountaineering, or another type of rope. The device 10 is shown in greater detail in FIGS. 2 and 3, and includes an elongate body 16 having a first end 18 and a second end 20. The elongate body 16 is generally cylindrical in shape in this example, but may be other shapes in other examples. There is an enlarged tip portion 22 extending from the first end 18 of the elongate body 16. In this example, the enlarged tip portion 22 includes a frusto-conical portion 24 proximal to the elongate body 16 and a conical portion 26 terminating in a pointed free end 28. The frusto-conical portion 24 flares radially outwardly from the elongate body 16 towards the conical portion 26. As best shown in FIG. 4, the enlarged tip portion 22 expands in diameter from a proximal end 30 to a midsection 32 then tapers in diameter towards the pointed free end 28. The pointed free end 28 may be rounded or blunted to minimize damage to the rope 14 during insertion of the device 10.

There is a through hole 34 extending through the elongate body 16 near the second end 20 thereof. The through hole 34 may have a chamfered edge 36 and the second end 20 may have a chamfered edge 38. As best shown in FIG. 1, the through hole 34 receives a cord 40 which is tied at its ends into a first knot 42 to form a loop. There is a second knot 44 in the cord 40 which divides the cord 40 into a first loop 46 and a second loop 48. The first loop 46 passes through the through hole 34 of the device 10. The second loop 48 is connected to a climbing harness 50 in this example. The second loop 48 is wrapped around a loop 52 of the climbing harness 50 and the device 10 is threaded through the second loop 48 to connect the cord 40 to the climbing harness 50. The chamfered edge 36 of the through hole 34, shown in FIGS. 2 and 3, may reduce wear and tear on the cord 40.

FIGS. 5 and 6 show front and rear end views of the device 10, respectively. As can be seen in FIG. 6, the enlarged tip portion 22 has a greater diameter than the elongate body 16. The width and shape of the enlarged tip portion 22 allows the device 10 to be inserted into the knot 12, and the device 10 to be retained within the knot 12, until the device 10 is removed by pulling on the cord 40, shown in FIG. 1.

As shown in FIG. 1, the knot 12 is initially formed loosely in the rope 14. The device 10 is inserted between loop portions 13 and 15 of the rope 14 forming the knot 12. The knot 12 is then manually tightened by pulling on end portions 17 and 19 of the rope 14. This causes the loop portions 13 and 15 to shrink and translate longitudinally relative to the elongate body 16 of the device 10 until reaching the enlarged tip portion 22. The enlarged tip portion 22 inhibits further longitudinal movement of the loop portions 13 and 15 so that the device 10 remains within the knot 12 as the knot 12 is manually tightened. When the rope 14 is placed under tension during use, for example, while climbing, the knot 12 further tightens over the elongate body 16.

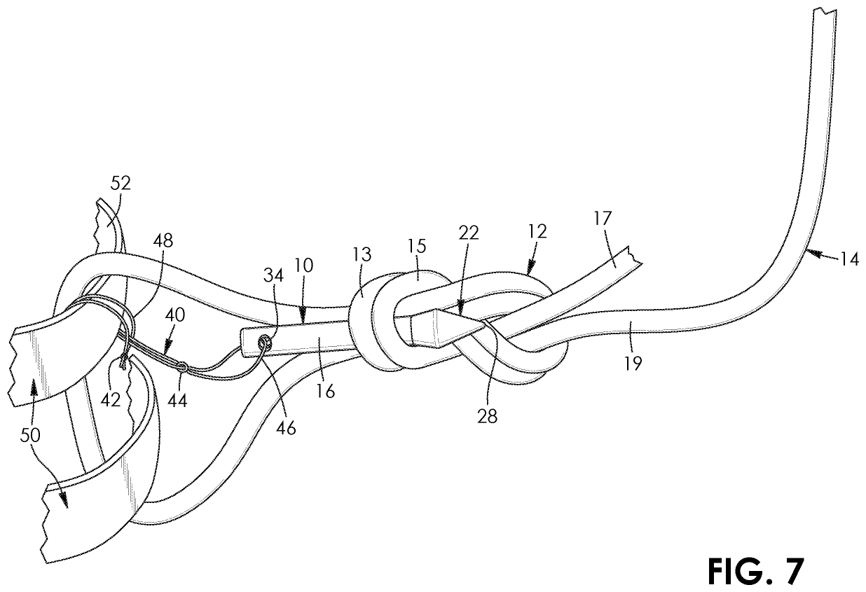

FIG. 7 shows the knot 12 tightened over the device 10. The device 10 prevents the knot 12 from completely tightening which aids in untying the knot 12 later on. The enlarged tip portion 22 also inhibits the device 10 from slipping out of the knot 12 due to its greater diameter relative to the elongate body 16. The enlarged tip portion 22 thus allows the device 10 to be retained in the knot 12 without using additional fixing means. This simplifies the device 10 itself and its application into the knot 12, as well as the effectiveness of the device 10 in loosening the knot 12 to better facilitate untying.

The device 10 can be removed from the knot 12 by pulling on the cord 40. For greater ease in removal, a user can insert one or two fingers in the first loop 46 adjacent the device 10 to pull the device 10 out of the knot 12. Since the enlarged tip portion 22 is wider than the elongate body 16, the enlarged tip portion 22 further expands the knot 12 as the device 10 is removed from the knot 12, which aids in untying the knot 12 afterwards. By connecting the device 10 to the climbing harness 50 via the second loop 48, the likelihood of losing the device 10 after removing it from the knot 12 is reduced. In the example shown in FIG. 1, the knot 12 is a figure-eight knot. However, the knot 12 may be a different type of knot in other examples.

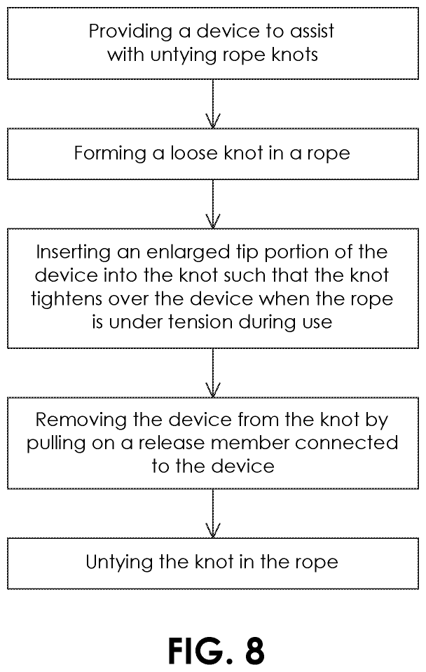

FIG. 8 shows the steps of using the device 10 to assist in untying a rope knot. A loose knot is formed in a rope prior to using the rope, for example, in climbing. The enlarged tip portion of the device is inserted into the knot such that the knot tightens over the device when the rope is under tension during use. When the knot is to be untied, the device is removed from the knot by pulling on a release member. The release member may be connected to the second end of the device opposite to the enlarged tip portion. As the device is removed from the knot, the elongate tip portion expands the knot. Removing the device leaves a space in the knot which allows the knot to be easily untied by hand.

It will be understood by a person skilled in the art that many of the details provided above are by way of example only, and are not intended to limit the scope of the invention which is to be determined with reference to the following claims.

What is claimed is:

1. A device to assist with untying rope knots, the device comprising:
an elongate body having a first end and a second end; and
an enlarged tip portion extending from the first end of the elongate body, the enlarged tip portion increasing in diameter from a proximal end thereof to an intermediate portion and decreasing in diameter from the intermediate portion to a distal end thereof;
wherein the enlarged tip portion is configured to be inserted into a loose knot in a rope so that the enlarged tip portion inhibits the device from slipping out of the knot after the knot is tightened.

2. The device of claim 1, wherein the enlarged tip portion includes a frusto-conical portion proximal to the elongate body and a conical portion terminating in a pointed free end.

3. The device of claim 2, wherein the frusto-conical portion flares radially outwardly from the elongate body towards the conical portion.

4. The device of claim 2, wherein the pointed free end is rounded.

5. The device of claim 1, wherein the elongate body includes a through hole near the second end thereof, the through hole receiving one end of a release member to assist in removal of the device from the knot.

6. The device of claim 5, wherein the other end of the release member is connectable to a climbing harness.

7. The device of claim 5, wherein the through hole has a chamfered edge.

8. The device of claim 1, wherein the second end of the elongate body is chamfered.

9. A method of tying and untying a knot in a rope, the method comprising:
providing the device of claim 1;
forming a loose knot in a rope;
inserting the enlarged tip portion of the device into the knot such that the knot tightens over the device when the rope is under tension during use;
removing the device from the knot after use, thereby expanding the knot; and
untying the expanded knot in the rope.

10. The method of claim 9, wherein removing the device from the knot includes pulling on a release member connected to the second end of the device opposite to the enlarged tip portion.

11. The method of claim 10, further including connecting the release member to a climbing harness prior to inserting the enlarged tip portion of the device into the knot.

12. In combination, a rope and a device for untying a knot in the rope:
the device comprising an elongate body having a first end and a second end, and an enlarged tip portion extending from the first end of the elongate body, the enlarged tip portion increasing in diameter from a proximal end thereof to an intermediate portion and decreasing in diameter from the intermediate portion to a distal end thereof;
wherein when the device is inserted into a loose knot formed in the rope, the enlarged tip portion retains the device in the loose knot as the knot is partially tightened, and the elongate body inhibits the knot from fully tightening, thereby facilitating untying of the knot.
